(19) United States
(12) Patent Application Publication
(10) Pub. No.: US 2004/0181774 A1
(43) Pub. Date: Sep. 16, 2004

(54) Work flow program generating apparatus and method

(75) Inventors: Motoyuki Ohsugi, Tokyo (JP); Masaki Izumi, Tokyo (JP); Isami Kawabata, Tokyo (JP); Ryutaro Asari, Tokyo (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/779,663

(22) Filed: Feb. 18, 2004

(30) Foreign Application Priority Data
Mar. 14, 2003 (JP) 2003-71018

(51) Int. Cl. G06F 9/44; G06F 17/60

(52) U.S. Cl. 717/102; 705/7; 705/8; 705/9

(57) ABSTRACT

A screen program including a program code for controlling a flow among a plurality of screens is generated by using flow definition information which defines information for controlling a work flow, and screen definition information which defines screen items of the plurality of screens used in the work flow.

### BACKGROUND OF THE INVENTION

1. Field of the invention

The present invention relates to an apparatus and method automatically generating a work flow program required to execute various types of processes based on a work flow.

2. Description of the Related Art

If work flow application software for a form process is developed, various types of programs such as a form input screen program, a work flow application/approval screen program, a pending form inquiry screen program, an approved form inquiry screen program, and a data linkage program used by a data linkage process to a backbone system of accounting, personnel, etc. must be developed. In this case, if one type of a form is put into a work flow, design, creation and test must be made respectively for these programs.

Conventional development assistance tools include a tool having a function for automatically generating various types of screen programs based on input screen design information (for example, see Japanese Patent Application Publication No. 09-198240).

However, the following problem exists in the above described development of work flow application software.

With a conventional development assistance tool, screen programs are generated only from screen design information. Therefore, a programmer must separately develop a program for controlling a flow among the screen programs. Comparing with normal system development which does not require to put a form into a work flow, load on a programmer increases, and the development efficiency of application software decreases.

### SUMMARY OF THE INVENTION

An object of the present invention is to provide a work flow program generating apparatus and method increasing the development efficiency of work flow application software.

The work flow program generating apparatus according to the present invention comprises a storing device and a generating device.

In the first aspect of the present invention, the storing device stores flow definition information which defines information for controlling a work flow, and screen definition information which defines screen items of a plurality of screens used in the work flow. The generating device reads the flow definition information and the screen definition information from the storing device, and generates a screen program which includes a program code for controlling a flow among the plurality of screens by using the read flow definition information and screen definition information.

In the second aspect of the present invention, the storing device stores flow definition information which defines information for controlling a work flow of a form process, and screen definition information which defines screen items of a plurality of screens used in the work flow.

The generating device reads the flow definition information and the screen definition information from the storing device, and generates a screen program for displaying a screen, on which data for updating a form table storing form data is input, and a screen program for displaying a screen, on which data of the form table is referred to, by using the read screen definition information.

Additionally, the generating device generates a screen program for displaying a screen, on which data for updating a work flow table storing data of the work flow of the form process is input, by using the read flow definition information and screen definition information, and also generates a screen program for displaying a screen, on which data of the form table is referred to, based on the data of the work flow table by using the read screen definition information.

### BRIEF DESCRIPTION OF THE DRAWINGS

FIG. 1 shows the principle of a work flow program generating apparatus according to the present invention;

FIG. 2 shows design information;

FIG. 3 is a flowchart showing an automatic generation process;

FIG. 4 is a flowchart showing a form input screen program automatic generation process;

FIG. 5 shows an application screen template;

FIG. 6 shows an apply button process template;

FIG. 7 shows a source code of an annual leave application screen program;

FIG. 8 shows an annual leave application screen;

FIG. 9 is a flowchart showing a work flow application screen program automatic generation process;

FIG. 10 shows an application forward screen template;

FIG. 11 shows a forward button process template;

FIG. 12 shows a source code of an annual leave application forward screen program;

FIG. 13 shows an annual leave application forward screen;

FIG. 14 is a flowchart showing an application form listing screen program automatic generation process;

FIG. 15 shows a listing screen template;

FIG. 16 shows a source code of an annual leave application listing screen program;

FIG. 17 shows an annual leave application listing screen;

FIG. 18 is a flowchart showing a form reference screen program automatic generation process;

FIG. 19 shows a reference screen template;

FIG. 20 shows a source code of an annual leave reference screen program;

FIG. 21 shows an annual leave reference screen;

FIG. 22 is a flowchart showing a pending form listing screen program;

FIG. 23 shows a source code of an annual leave pending listing screen program;

FIG. 24 shows an annual leave pending listing screen;

FIG. 25 is a flowchart showing a form approval screen program automatic generation process;

FIG. 26 shows an approval screen template;

FIG. 27 shows a source code of an annual leave approval screen program;

FIG. 28 shows an annual leave approval screen;

FIG. 29 is a flowchart showing a data linkage program automatic generation process;

FIG. 30 is a flowchart showing a linkage start button press time process creation process;

FIG. 31 shows a data linkage screen template;

FIG. 32 shows a linkage start button template;

FIG. 33 shows a source code of an annual leave data linkage program;

FIG. 34 shows an annual leave data linkage screen;

FIG. 35 shows a process executed when a form application is made;

FIG. 36 shows a process executed when a form is withdrawn;

FIG. 37 shows a process executed when a form is approved;

FIG. 38 shows the configuration of an information processing device; and

FIG. 39 shows storage media.

### DESCRIPTION OF THE PREFERRED EMBODIMENTS

Hereinafter, a preferred embodiment according to the present invention is described in detail with reference to the drawings.

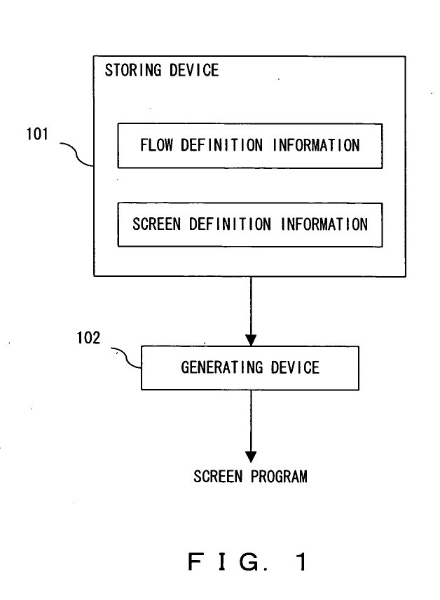

FIG. 1 shows the principle of a work flow program generating apparatus according to the present invention. The work flow program generating apparatus shown in FIG. 1 comprises a storing device 101 and a generating device 102.

In the first aspect of the present invention, the storing device 101 stores flow definition information which defines information for controlling a work flow, and screen definition information which defines screen items of a plurality of screens used in the work flow. The generating device 102 reads the flow definition information and the screen definition information from the storing device 101, and generates a screen program which includes a program code for controlling a flow among the plurality of screens by using the read flow definition information and screen definition information.

With such a work flow program generating apparatus, the flow definition information is prepared beforehand separately from the screen definition information, whereby the screen program which includes the program code for controlling the flow is automatically generated. As a result, the amount of operations of a programmer is significantly reduced, and the development efficiency of work flow application software is increased.

In the second aspect of the present invention, the storing device 101 stores flow definition information which defines information for controlling a work flow of a form process, and screen definition information which defines screen items of a plurality of screens used in the work flow.

The generating device 102 reads the flow definition information and the screen definition information from the storing device 101, and generates a screen program for displaying a screen, on which data for updating a form table storing form data is input, and a screen program for displaying a screen, on which data of the form table is referred to, by using the read screen definition information.

Additionally, the generating device 102 generates a screen program for displaying a screen, on which data for updating a work flow table storing data of the work flow of the form process is input, by using the read flow definition information and screen definition information, and also generates a screen program for displaying a screen, on which data of the form table is referred to, based on the data of the work flow table by using the read screen definition information.

With such a work flow program generating apparatus, the flow definition information is prepared beforehand separately from the screen definition information, whereby the screen program for updating the work flow table, and the screen program for referring to the work flow table are automatically generated along with the screen program for updating the form data and the screen program for referring to the form data.

The update and the reference of the work flow table correspond to a part of the flow control. Therefore, a program corresponding to this part is automatically generated, whereby the amount of operations of a programmer is significantly reduced, and the development efficiency of work flow application software is increased.

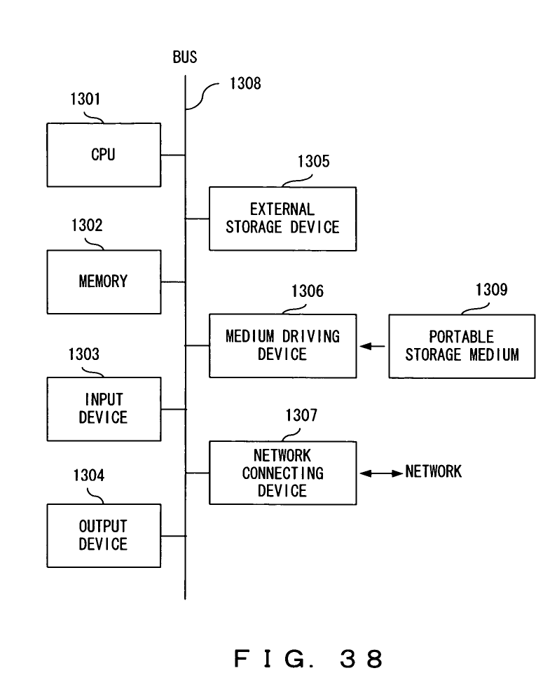

The storing device 101 shown in FIG. 1 corresponds, for example, to an external storage device 1305 which is shown in FIG. 38 and will be described later, whereas the generating device 102 shown in FIG. 1 corresponds to a CPU (Central Processing Unit) 1301 and a memory 1302, which are shown in FIG. 38.

In this preferred embodiment, seven types of programs such as a form input screen program, a work flow application screen program, an application form listing screen program, a form reference screen program, a pending form listing screen program, a form approval screen program, and a data linkage program are automatically generated from form screen design information and form flow design information, which are managed by a database.

The form screen design information is screen definition information which defines input/output items of each screen used in a form process, whereas the form flow design information is flow definition information which defines information for controlling a work flow of the form process independently of the input/output items of each screen. The automatic generation process according to this preferred embodiment is outlined as follows.

1. Screen application software (a form input screen program, an application form listing screen program, a pending form listing screen program, and a form approval screen program), which do not include a flow control program, are automatically generated from the form screen design information.

2. Screen application software (a work flow application screen program and a form reference screen program), which include a flow control program, are automatically generated from the form screen design information and the form flow design information.

3. Linkage application software (a data linkage program), which is used in a data linkage process to a backbone system, is automatically generated from the form screen design information.

As described above, the seven types of programs are automatically generated at the same time, whereby productivity in the development of work flow application software is improved. Especially, a flow control program is automatically generated, whereby the amount of operations of a programmer is significantly reduced, and the development efficiency of application software is increased.

Furthermore, respective screen programs and linkage application software are automatically generated from the same form screen design information, whereby input/output items, a data type, etc. of the respective screens are unified, and the quality of application software is improved.

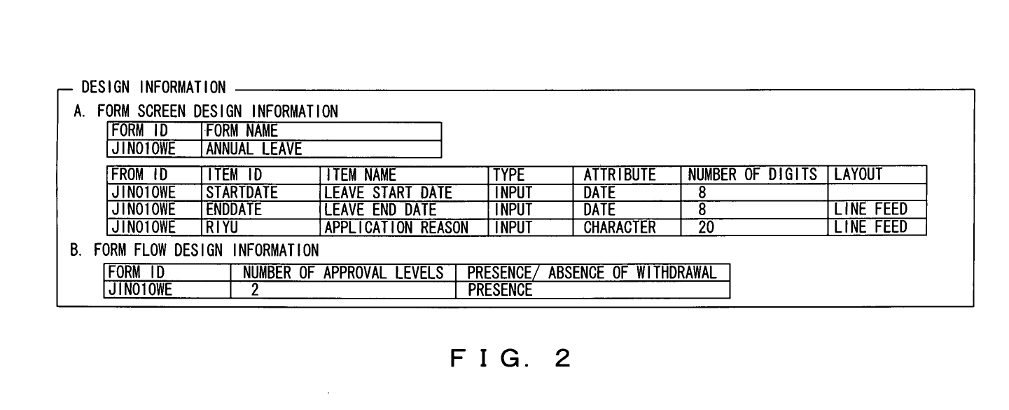

FIG. 2 exemplifies form screen design information and form flow design information, which are stored in a database. The form screen design information A is composed of a form identifier (form ID), a form name, an item identifier (item ID), an item name, a type (input, output, etc.), an attribute (date, character, etc.), the number of digits, and a layout (line feed, etc.). In the meantime, the form flow design information B is composed of a form identifier (form ID), the number of approval levels, and the presence/absence of withdrawal.

The number of approval levels represents the number of logical hierarchical levels of approvers who approve an item input to a form. If the number of approval levels is n, a form is approved after approval is given n times. The presence/absence of withdrawal represents whether or not withdrawal of a form (application cancellation) by an applicant can be made. If the presence/absence of withdrawal indicates the presence of withdrawal, a form can be withdrawn. If the presence/absence of withdrawal indicates the absence of withdrawal, a form cannot be withdrawn.

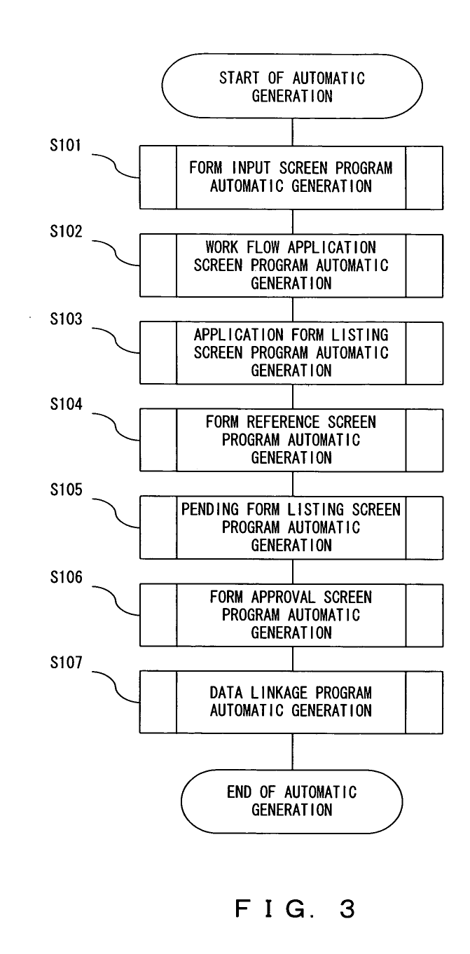

FIG. 3 is a flowchart showing an automatic generation process executed by the work flow program generating apparatus. The work flow program generating apparatus is configured, for example, by an information processing device, and executes the automatic generation processes by executing a predetermined program.

The work flow program generating apparatus first executes a form input screen program automatic generation process (step S101), then executes a work flow application screen program automatic generation process (step S102), further executes an application form listing screen program automatic generation process (step S103), and executes a form reference screen program automatic generation process (step S104).

Next, the work flow program generating apparatus executes a pending form listing screen program automatic generation process (step S105), executes a form approval screen program automatic generation process (step S106), and executes a data linkage program automatic generation process (step S107).

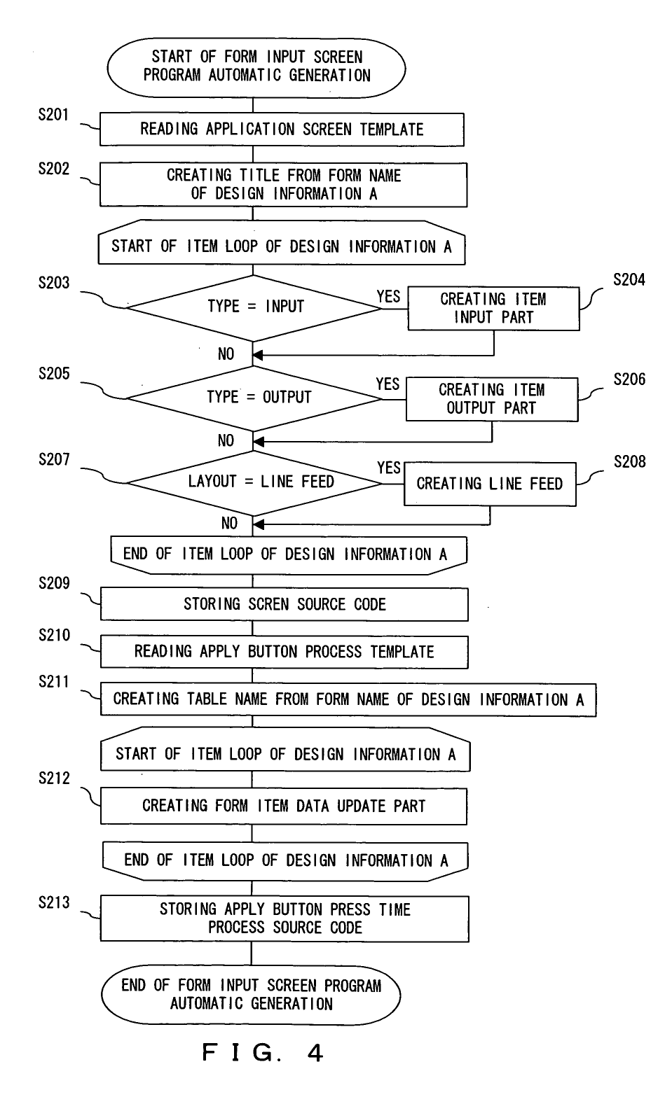

Next, the automatic generation processes are described in further detail with reference to FIGS. 4 to 34.

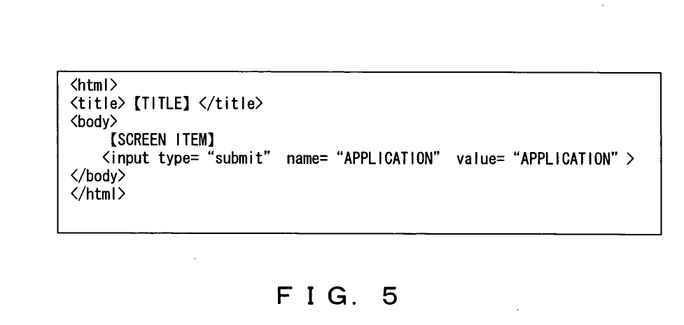

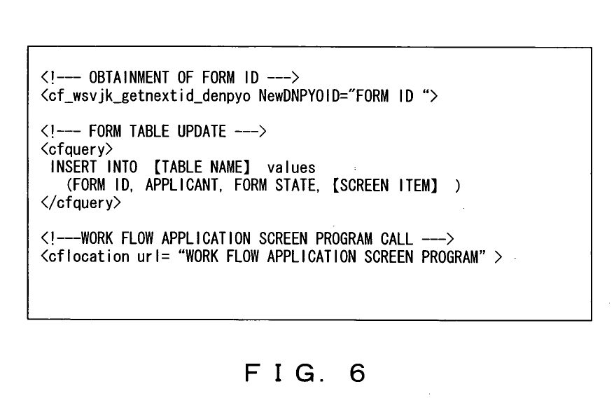

FIG. 4 is a flowchart showing the form input screen program automatic generation process in step S101 shown in FIG. 3. FIGS. 5 and 6 respectively show an application screen template and an apply button process template, which are used in this process.

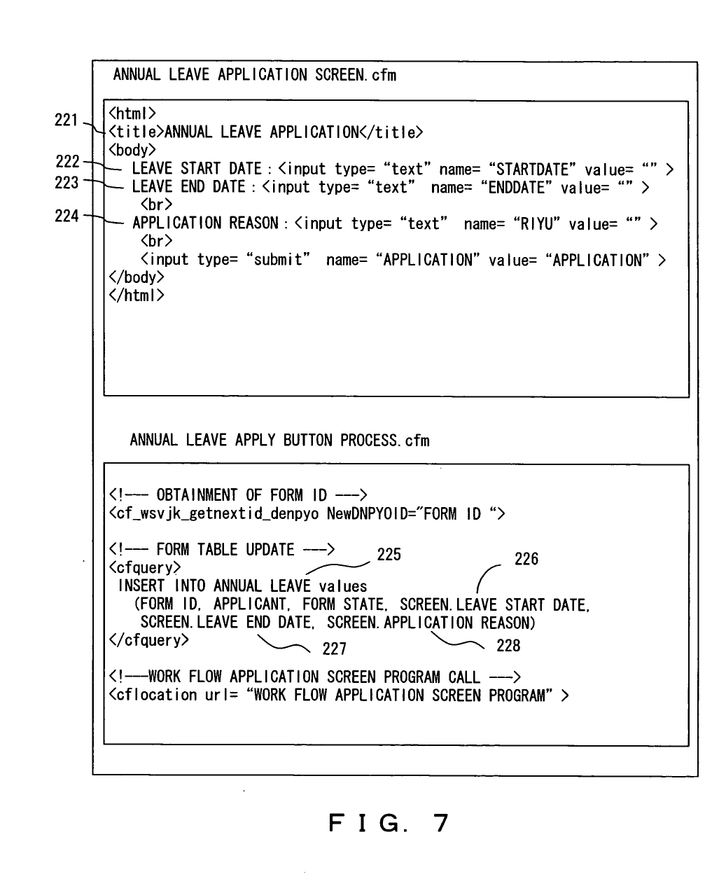

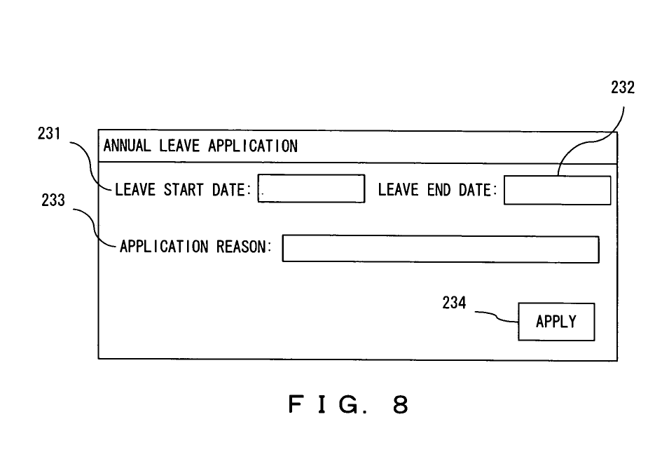

FIG. 7 exemplifies a source code (program code) of a form input screen program (annual leave application screen program) generated with this process. FIG. 8 exemplifies a form input screen (annual leave application screen) displayed when the form input screen program is executed. The annual leave application screen program shown in FIG. 7 is composed of a file of a screen source code “annual leave application screen.cfm”, and a file of an apply button press time process source code “annual leave apply button process.cfm”.

The work flow program generating apparatus first generates a screen source code (step S201 to S209), and then generates an apply button press time process source code (steps S210 to S213).

In the generation of the screen source code, the application screen template shown in FIG. 5 is first read (step S201), and a title is created from a form name of the form screen design information A (step S202). For example, the form name is “annual leave” in the form screen design information A shown in FIG. 2. Therefore, a title 221 (annual leave application) shown in FIG. 7 is created.

Next, a screen item creation process (step S203 to S208) is repeated by the number of items of the form screen design information A, and a generated screen source code is stored (step S209).

In this screen item creation process, it is checked whether or not an item type is an input (step S203). If the item type is an input, an item input part is created (step S204). Next, it is checked whether or not the item type is an output (step S205). If the item type is an output, an item output part is created (step S206). Then, it is checked whether or not an item layout is line feed (step S207). If the item layout is line feed, line feed is created (step S208).

For example, three input items such as “leave start date”, “leave end date”, and “application reason” are defined in the form screen design information A shown in FIG. 2. Therefore, three screen items 222, 223, and 224 shown in FIG. 7 are created as item input parts. For the screen items 223 and 224 among these items, line feed is created.

In the generation of the apply button press time process source code, the apply button process template shown in FIG. 6 is first read (step S210), and a table name of a form table storing data of a form based on the form name of the form screen design information A (step S211). For example, the form name is “annual leave” in the form screen design information A shown in FIG. 2. Therefore, a table name 225 (annual leave) shown in FIG. 7 is created.

Next, a screen item creation process (step S212) is repeated by the number of items of the form screen design information A, and a generated apply button press time process source code is stored (step S213). In the screen item creation process, a screen item to be updated in the form table is created as a form item data update part.

For example, the three input items such as the “leave start date”, the “leave end date”, and the “application reason” are defined in the form screen design information A shown in FIG. 2. Therefore, three screen items 226, 227, and 228 shown in FIG. 7 are created as form item data update parts.

When the annual leave application screen program thus generated is executed, the annual leave application screen shown in FIG. 8 is displayed. If an applicant inputs a leave start date 231, a leave end date 232, and an application reason 233, and presses (clicks) an apply button 234, the input item data are stored in the annual leave table along with the form ID and the applicant name, and the form state is set to “waiting for primary approval”. Then, the work flow application screen program is called.

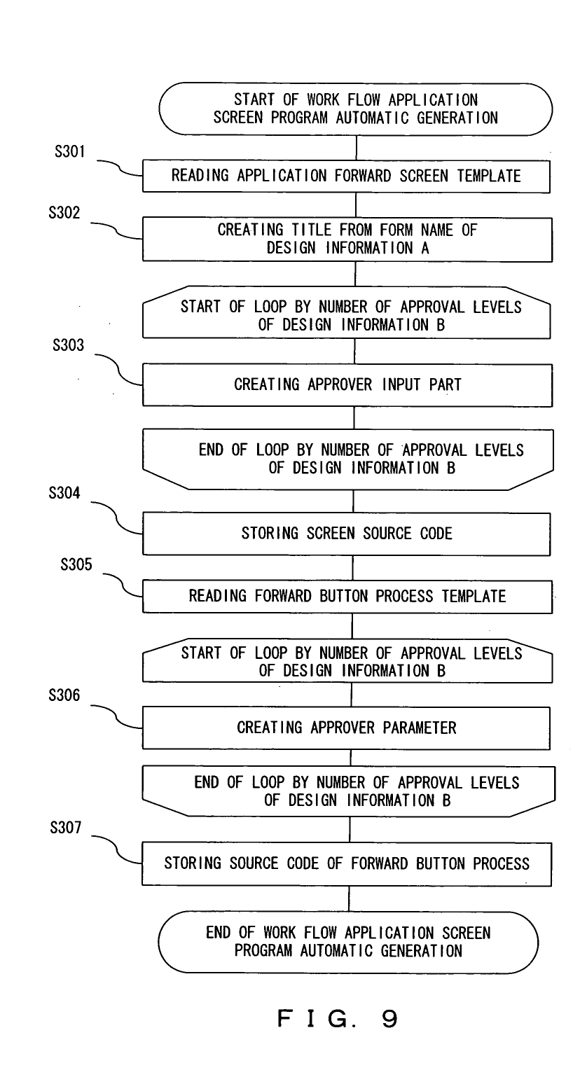

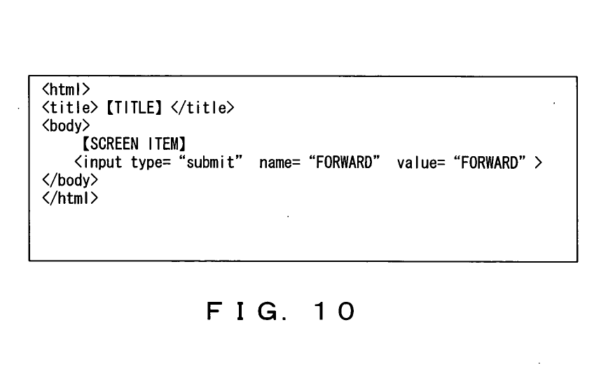

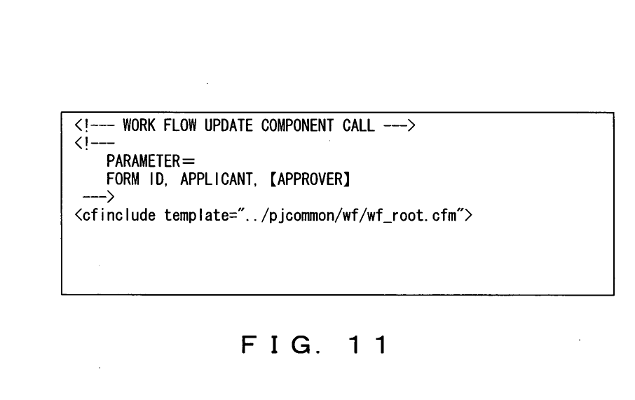

FIG. 9 is a flowchart showing the work flow application screen program automatic generation process in step S102 of FIG. 3. FIGS. 10 and 11 respectively exemplify an application forward screen template and a forward button process template, which are used in this process.

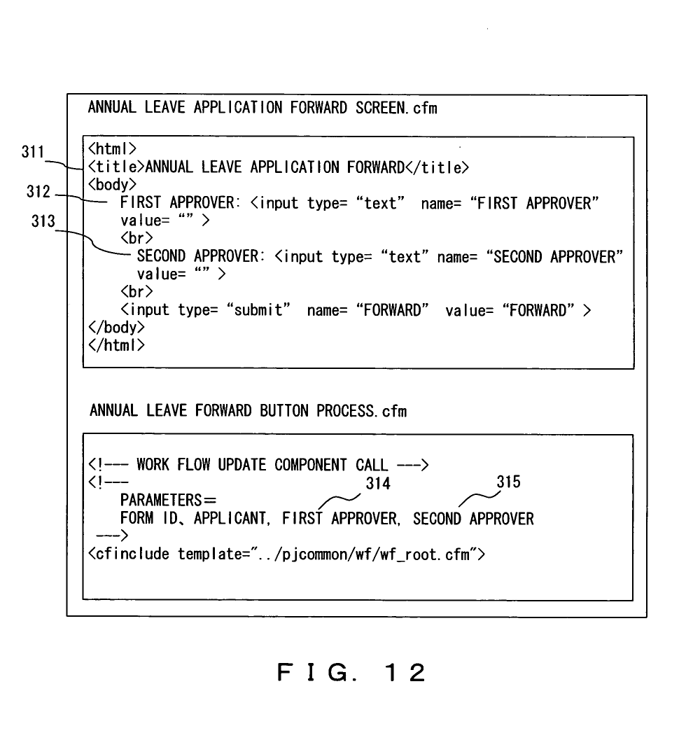

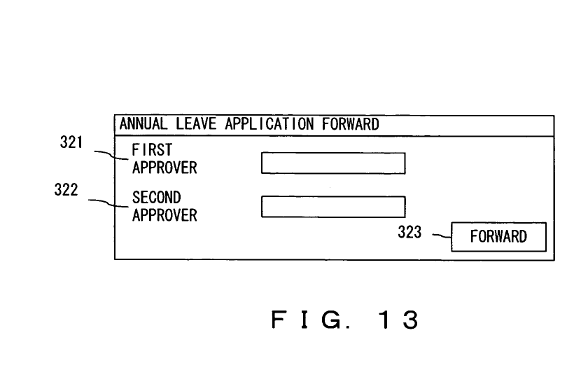

FIG. 12 exemplifies a source code of a work flow application screen program (annual leave application forward screen program) generated with this process. FIG. 13 exemplifies a work flow application screen (annual leave application forward screen) displayed when the work flow application screen program is executed. The annual leave application forward screen program shown in FIG. 12 is composed of a file of a screen source code “annual leave application forward screen.cfm”, and a file of a forward button press time process source code “annual leave forward button process.cfm”.

The work flow program generating apparatus first generates a screen source code (steps S301 to S304), and then generates a forward button process source code (steps S210 to S213).

In the generation of the screen source code, the application forward screen template shown in FIG. 10 is first read (step S301), and a title is created from the form name of the form screen design information A (step S302). For example, the form name is “annual leave” in the form screen design information A shown in FIG. 2. Therefore, a title 311 (annual leave application forward) shown in FIG. 12 is created.

Next, a screen item creation process (step S303) is repeated by the number of approval levels of form flow design information B, and a generated screen source code is stored (step S304). In this screen item creation process, an input part of an approver name on a work flow application screen is created.

For example, the number of approval levels is 2 in the form flow design information B shown in FIG. 2. Therefore, the screen item creation process is repeated twice, and an input part 312 of the first approver and an input part 313 of the second approver, which are shown in FIG. 12, are created.

In the generation of the forward button process source code, the forward button process template shown in FIG. 11 is first read (step S305), a parameter creation process (step S306) is repeated by the number of approval levels of the form flow design information B, and a generated forward button process source code is stored (step S307). In this parameter creation process, an approver parameter used by a work flow update component is created. The work flow update component updates an item specified by the approver parameter among items of the work flow table storing data of a work flow.

For example, the number of approval levels is 2 in the form flow design information B shown in FIG. 2. Therefore, the parameter creation process is repeated twice, and two approver parameters 314 and 315 shown in FIG. 12 are created.

When the annual leave application forward screen program thus generated is executed, the annual leave application forward screen shown in FIG. 13 is displayed. If an applicant inputs approver names of the first approver 321 and the second approver 322, and presses (clicks) a forward button 323, the input approver names are stored in the work flow table along with the form ID and the applicant name.

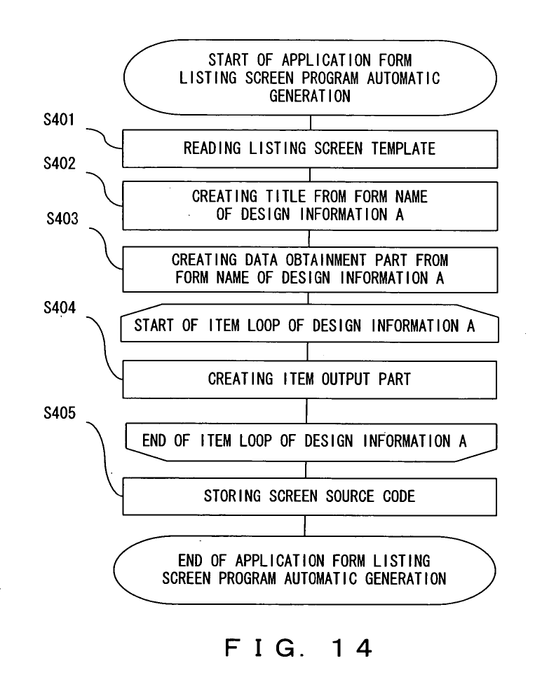

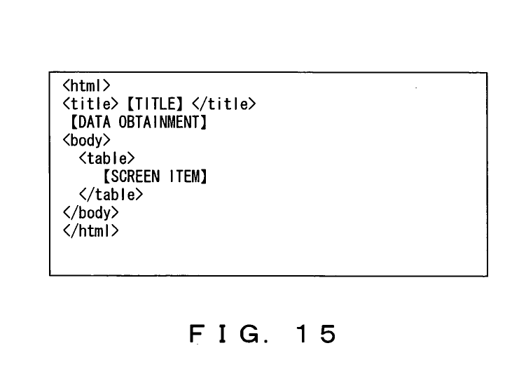

FIG. 14 is a flowchart showing the application form listing screen program automatic generation process in step S103 of FIG. 3. FIG. 15 exemplifies a listing screen template used in this process.

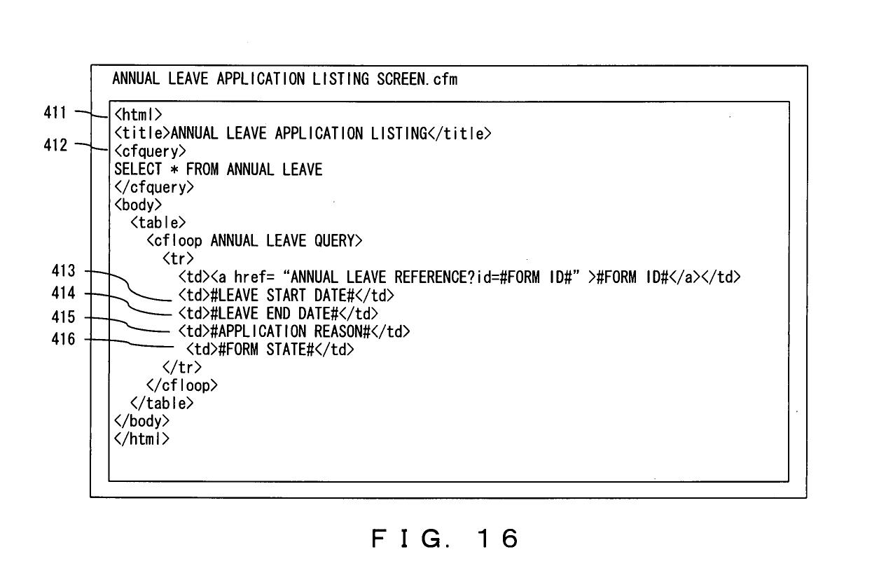

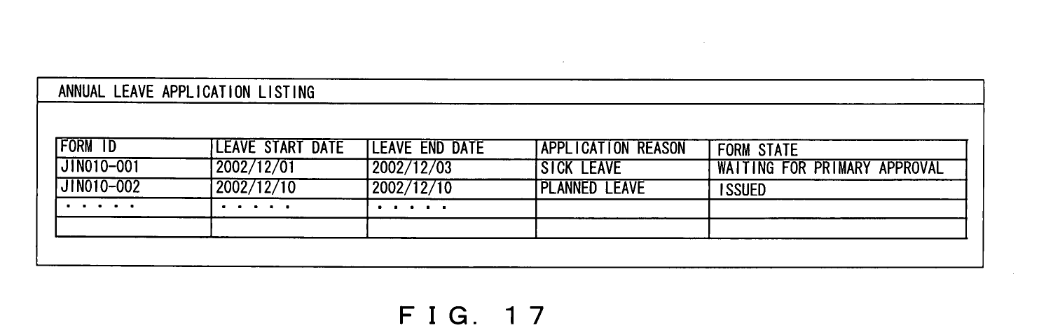

FIG. 16 exemplifies a source code of an application form listing screen program (annual leave application listing screen program) generated with this process. FIG. 17 exemplifies an application form listing screen (annual leave application listing screen) displayed when the application form listing screen program is executed. The application form listing screen program shown in FIG. 16 is composed of a file of a screen source code “annual leave application listing screen.cfm”.

The work flow program generating apparatus first reads the listing screen template shown in FIG. 15 (step S401), and creates a title from the form name of the form screen design information A (step S402). For example, the form name is “annual leave” in the form screen design information A shown in FIG. 2. Therefore, a title 411 (annual leave application listing) shown in FIG. 16 is created.

Next, a data obtainment part including the table name of the form table is created from the form name of the form screen design information A (step S403). For example, the form name is “annual leave” in the form screen design information A shown in FIG. 2. Therefore, a data obtainment part 412 shown in FIG. 16 is created. In the data obtainment part 412, it is described that data to be obtained is an annual leave table.

Next, a screen item creation process (step S404) is repeated by the number of items of the form screen design information A, and a generated screen source code is stored (step S405). In this screen item creation process, an item of the form screen design information A is created as an item output part.

For example, the three items such as the “leave start date”, the “leave end date”, and the “application reason ” are defined in the form screen design information A shown in FIG. 2. Therefore, three screen items 413, 414, and 415 shown in FIG. 16 are created as item output parts. Furthermore, a screen item 416 (form state) which represents the current state of the form process in the work flow is added as an item output part.

When the annual leave application listing screen program thus generated is executed, the annual leave application listing screen shown in FIG. 17 is displayed. This screen includes a listing of forms which waits for approval and have been approved, and is referred to by an applicant. In this example, the following four form states are used.

(1) waiting for primary approval: state where the applicant has forwarded the form to the first approver

(2) waiting for secondary approval: state where the first approver has approved the form

(3) issued: state where the applicant has withdrawn the form, or the approver (the first or the second approver) has denied the form

(4) approved: state where the second approver has approved the form

Generally, n states of waiting for approval from “waiting for primary approval” to “waiting for n-ary approval” are used if the number of approval levels is n. A state where an nth approver (the last approver) has approved the form becomes the approved state. When the applicant clicks a particular form ID on the annual leave application listing screen, a reference screen of the corresponding form is displayed.

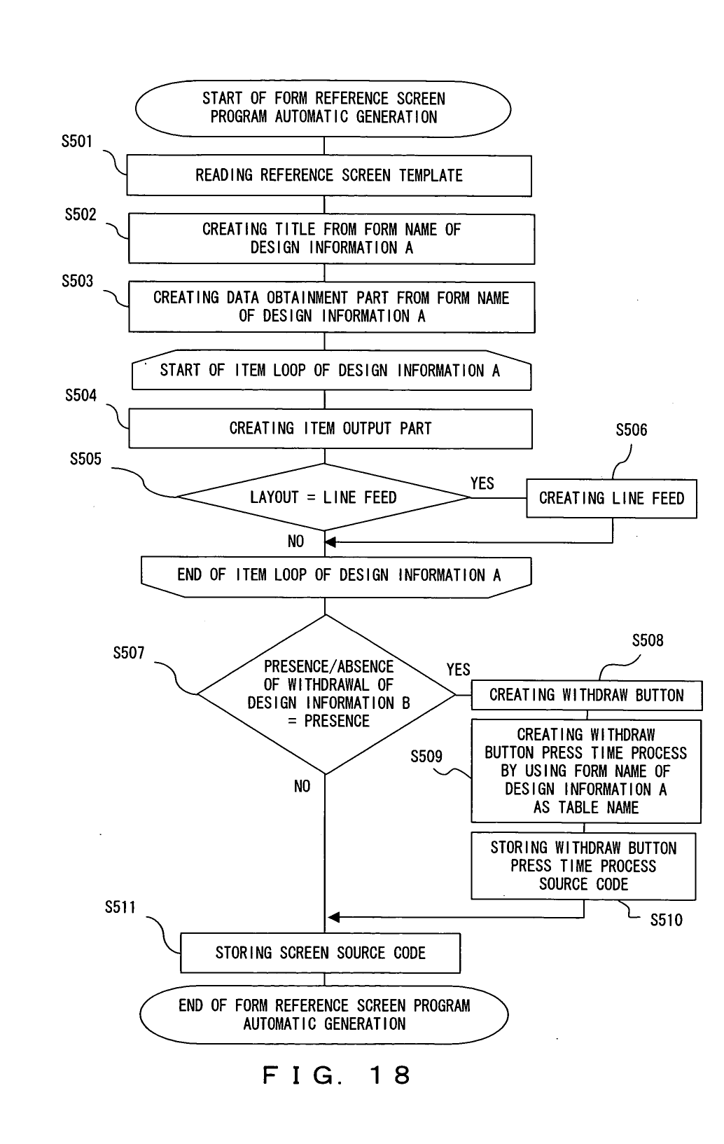

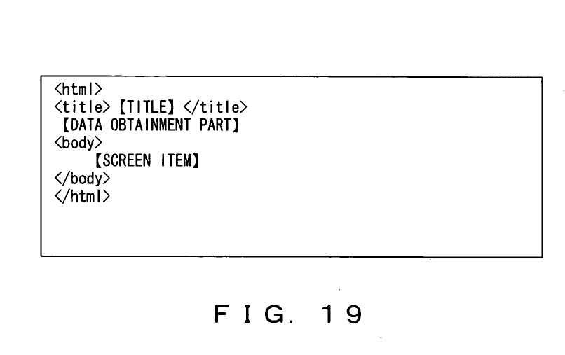

FIG. 18 is a flowchart showing the form reference screen program automatic generation process in step S104 shown in FIG. 3. FIG. 19 exemplifies a reference screen template used in this process.

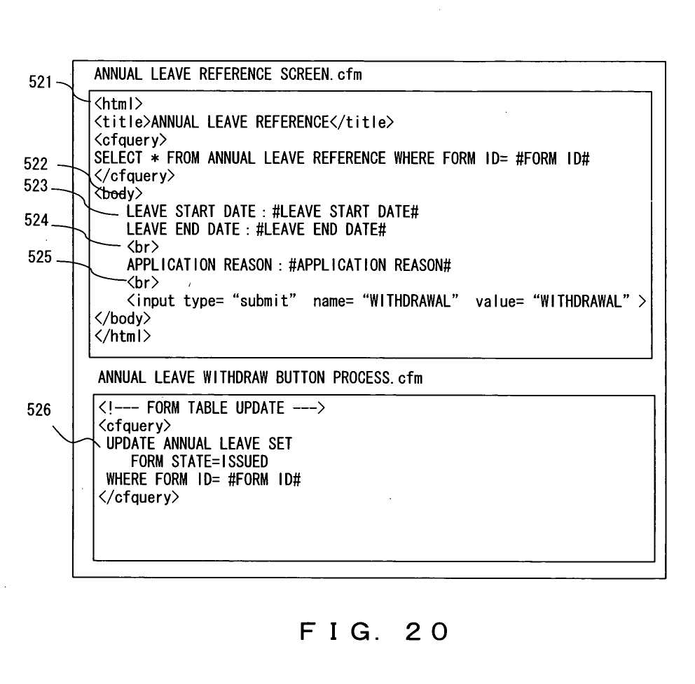

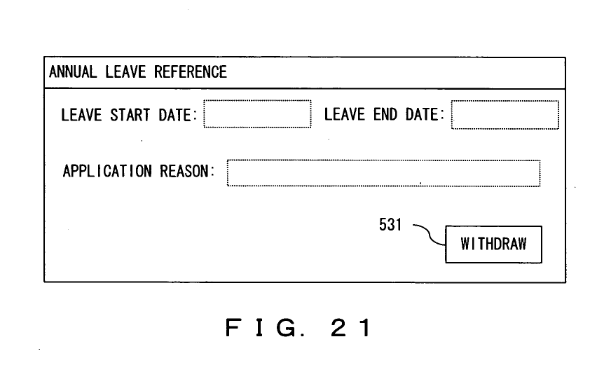

FIG. 20 exemplifies a source code of a form reference screen program (annual leave reference screen program) generated with this process. FIG. 21 exemplifies a form reference screen (annual leave reference screen) displayed when the form reference screen program is executed. The annual leave reference screen program shown in FIG. 20 is composed of a file of a screen source code “annual leave reference screen.cfm”, and a file of a withdraw button press time process source code “annual leave withdraw button process.cfm”.

The work flow program generating apparatus first reads the reference screen template shown in FIG. 19 (step S501), and creates a title name from the form name of the form screen design information A (step S502). For example, the form name is “annual leave” in the form screen design information A shown in FIG. 2. Therefore, a title 521 (annual leave reference) shown in FIG. 20 is created.

Next, a screen item creation process (steps S504 to S506) is repeated by the number of items of the form screen design information A. In this screen item creation process, an item of the form screen design information A is created as an item output part (step S504). Next, it is checked whether or not the layout of the item is line feed (step S505). If the layout of the item is line feed, line feed is created (step S506).

For example, the three items such as the “leave start date”, the “leave end date”, and the “application reason” are defined in the form screen design information A shown in FIG. 2. Therefore, three screen items 522, 523, and 524 are created as item output parts. For the screen items 523 and 524 among these items, line feed is created.

Next, it is checked whether or not the presence/absence of withdrawal of the form flow design information B indicates “presence” (step S507).

If the presence/absence of withdrawal indicates “presence”, a withdraw button is created (step S508), and a source code of a withdraw button press time process, which uses the form name of the form screen design information A as a table name, is created (step S509). Then, the source code of the withdraw button press time process is stored (step S510), and the source code of the screen code is stored (step S511). If the presence/absence of withdrawal indicates “absence”, the source code of the screen code is stored without creating the source code of the withdraw button press time process (step S511).

For example, the presence/absence of withdrawal indicates “presence” in the form flow design information B shown in FIG. 2. Therefore, a process 525 for displaying the withdraw button, and a process 526 for updating the annual leave table, which are shown in FIG. 20, are created.

When the annual leave reference screen program thus generated is executed, the annual leave reference screen shown in FIG. 21 is displayed. If an applicant presses (clicks) the withdraw button 531, the form state of the corresponding form in the annual leave table is changed to “issued”.

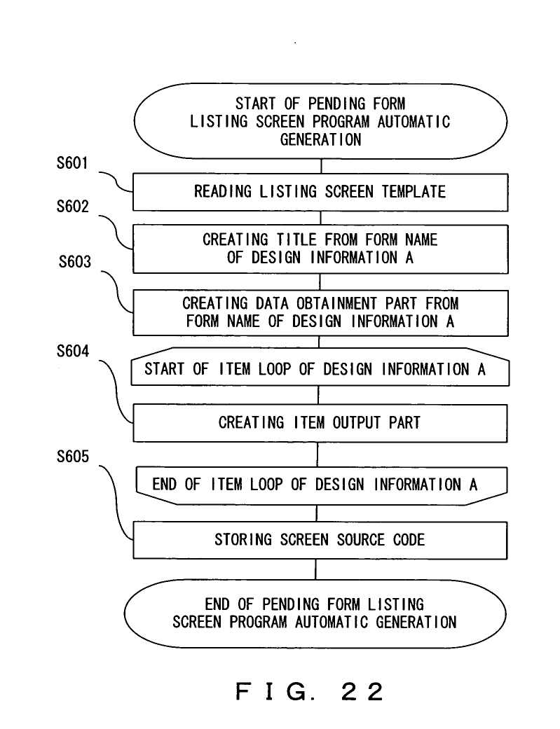

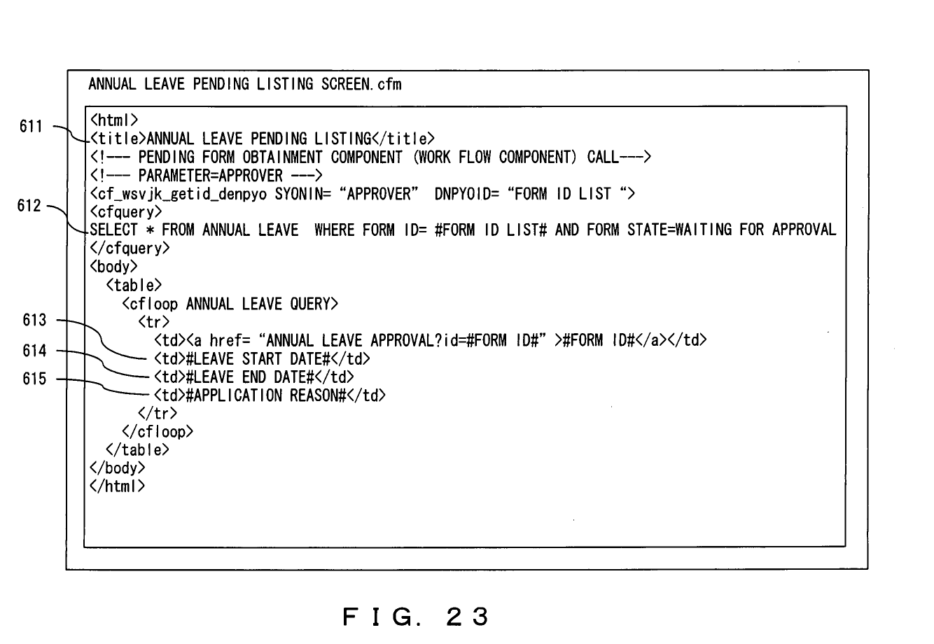

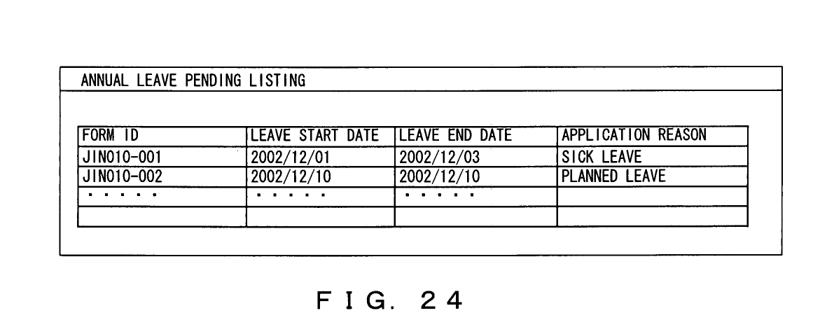

FIG. 22 is a flowchart showing the pending form listing screen program automatic generation process in step S105 of FIG. 3. FIG. 23 exemplifies a source code of a pending form listing screen program (annual leave pending listing screen program) generated with this process. FIG. 24 exemplifies a pending form listing screen (annual leave pending listing screen) displayed when the pending form listing screen program is executed. The pending form listing screen program shown in FIG. 24 is composed of a file of a screen source code “annual leave pending listing screen.cfm”.

The work flow program generating apparatus first reads the listing screen template shown in FIG. 15 (step S601), and creates a title from the form name of the form screen design information A (step S602). For example, the form name is “annual leave” in the form screen design information A shown in FIG. 2. Therefore, a title 611 (annual leave pending listing) shown in FIG. 23 is created.

Next, a data obtainment part including the table name of the form table is created from the form name of the form screen design information A (step S603). For example, the form name is “annual leave” in the form screen design information A shown in FIG. 2. Therefore, a data obtainment part 612 shown in FIG. 23 is created. In the data obtainment part 612, it is described that a pending form obtainment component is called by using an approver as a parameter, and data is obtained from the annual leave table.

The pending form obtainment component is one of work flow components, and reads a form ID of a form including a given approver name from the work flow table. Then, the pending form obtainment component refers to the form table by using the read form ID as a key, and obtains data of a form the state of which is “waiting for approval” given by the approver. In this way, the pending form listing screen can be displayed.

Next, a screen item creation process (step S604) is repeated by the number of items of the form screen design information A, and a generated screen source code is stored (step S605). In this screen item creation process, an item of the form screen design information A is created as an item output part.

For example, the three items such as the “leave start date”, the “leave end date”, and the “application reason” are defined in the form screen design information A shown in FIG. 2. Therefore, three screen items 613, 614, and 615 shown in FIG. 23 are created as item output parts.

When the annual leave pending listing screen program thus generated is executed, the annual leave pending listing screen shown in FIG. 24 is displayed. This screen is referred to by an approver. With the click of a particular form ID by an approver, an approval screen of a corresponding form is displayed.

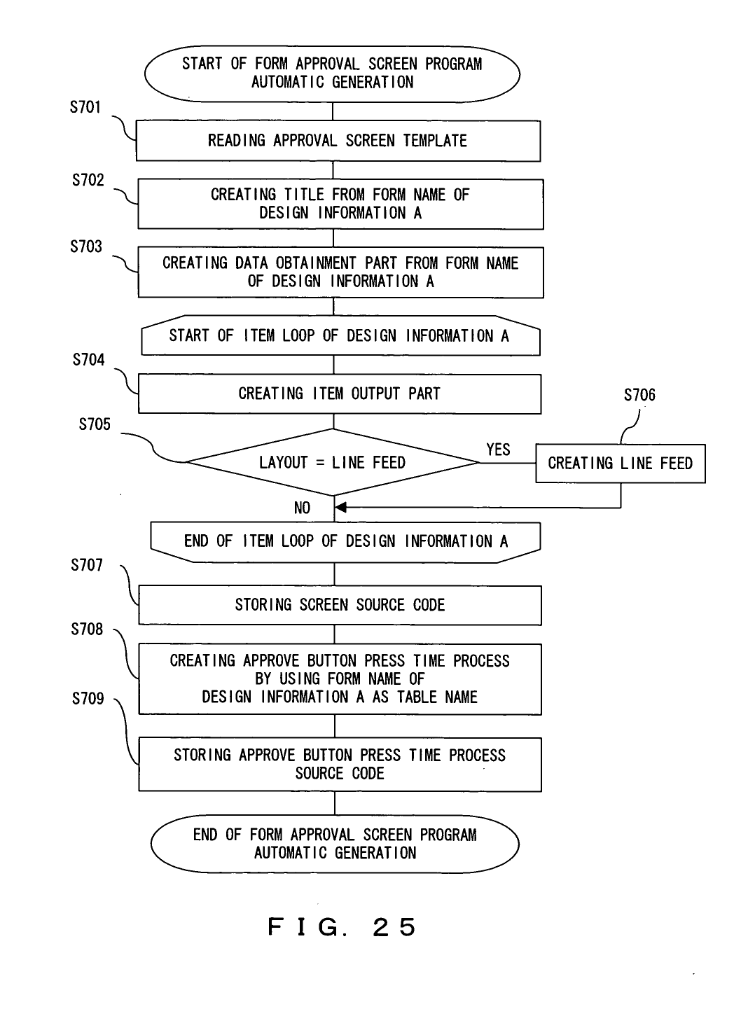

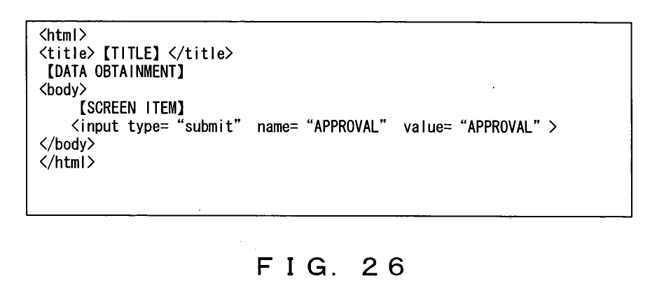

FIG. 25 is a flowchart showing the form approval screen program automatic generation process in step S106 of FIG. 3. FIG. 26 exemplifies an approval screen template used in this process.

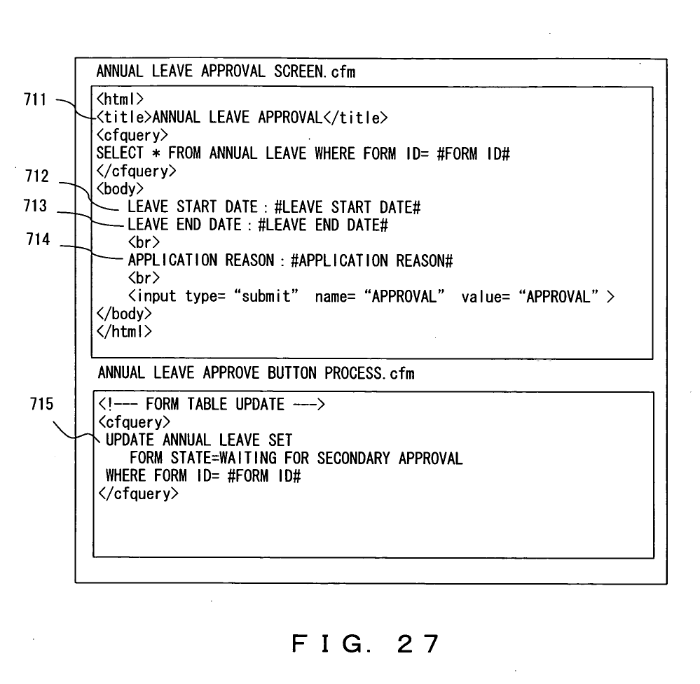

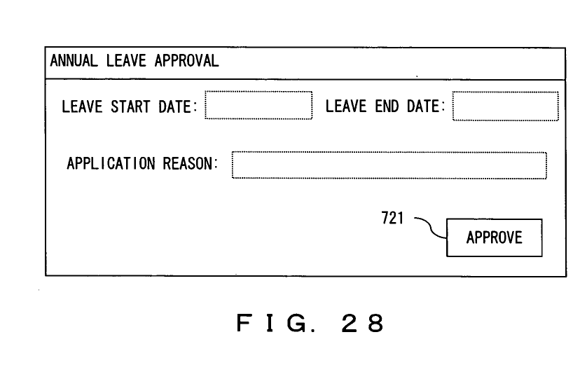

FIG. 27 exemplifies a source code of a form approval screen program (annual leave approval screen program) generated with this process. FIG. 28 exemplifies a form approval screen (annual leave approval screen) displayed when the form approval screen program is executed. The annual leave approval screen program shown in FIG. 27 is composed of a file of a screen source code “annual leave approval screen.cfm”, and a file of an approve button press time process source code “annual leave approve button process.cfm”.

The work flow program generating apparatus first generates a screen source code (steps S701 to S707), and next generates an approve button press time process source code (steps S708 to S709).

In the generation of the screen source code, the approval screen template shown in FIG. 26 is first read (step S701), and a title is created from the form name of the form screen design information A (step S702). For example, the form name is “annual leave” in the form screen design information A shown in FIG. 2. Therefore, a title 711 (annual leave approval) shown in FIG. 27 is created.

Next, a screen item creation process (steps S704 to S706) is repeated by the number of items of the form screen design information A, and a generated screen source code is stored (step S707). In this screen item creation process, an item of the form screen design information A is created as an item output part (step S704). Next, it is checked whether or not a layout of the item is line feed (step S705). If the layout of the item is line feed, line feed is created (step S706).

For example, the three items such as the “leave start date”, the “leave end date”, and the “application reason” are defined in the form screen design information A shown in FIG. 2. Therefore, three screen items 712, 713, and 714 shown in FIG. 27 are created as item output parts. For the screen items 713 and 714 among these items, line feed is created.

In the generation of the approve button press time process source code, a source code of an approve button press time process is created by using the form name of the form screen design information A as a table name (step S708), and the source code is stored (step S709) In this way, a process 715 for updating the annual leave table, which is shown in FIG. 27, is created.

When the annual leave approval screen program thus generated is executed, the annual leave approval screen shown in FIG. 28 is displayed. With the press (click) of an approve button 721 by an approver, the form state of a corresponding form in the annual leave table is changed to the state of “waiting for approval” given by the next approver, or to “approved”.

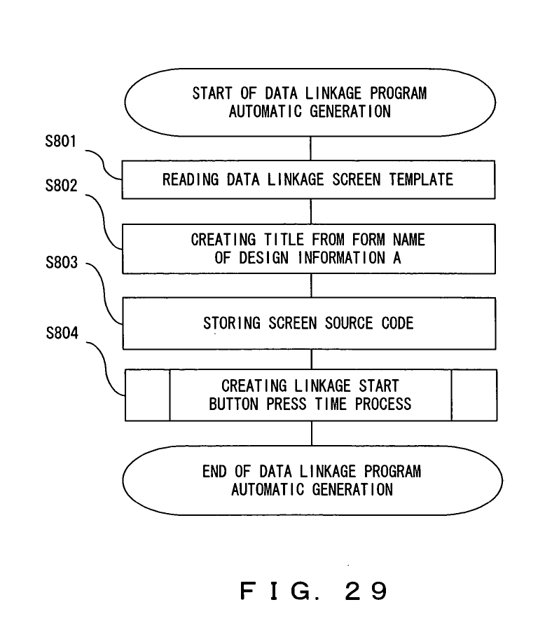

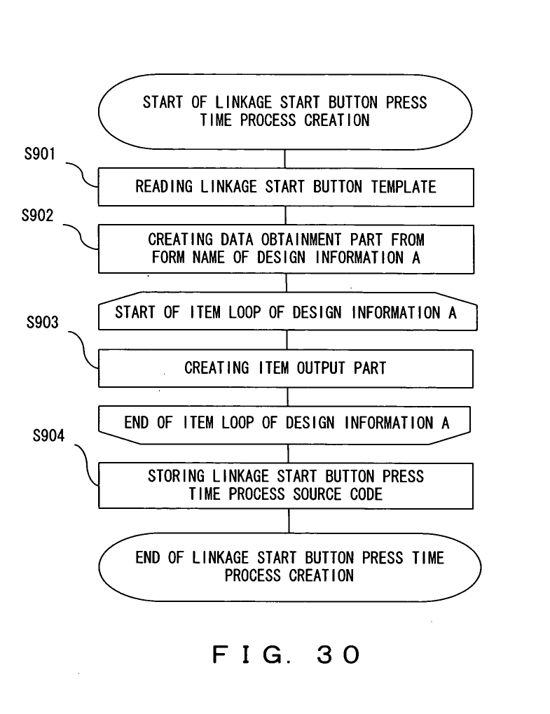

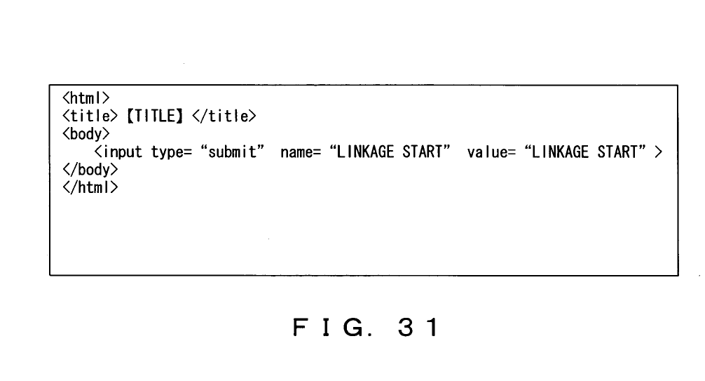

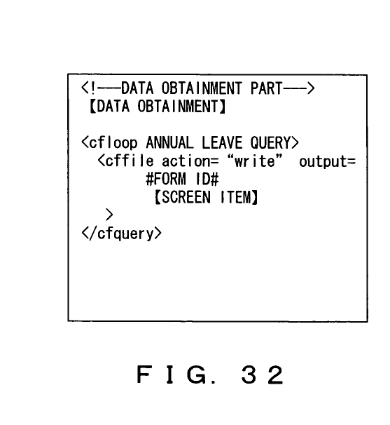

FIG. 29 is a flowchart showing the data linkage program automatic generation process in step S107 shown in FIG. 3. FIG. 30 is a flowchart showing a linkage start button press time process creation process in step S804 of FIG. 29. FIGS. 31 and 32 respectively exemplify a data linkage screen template used in the data linkage program automatic generation process, and a linkage start button template used in the linkage start button press time process creation process.

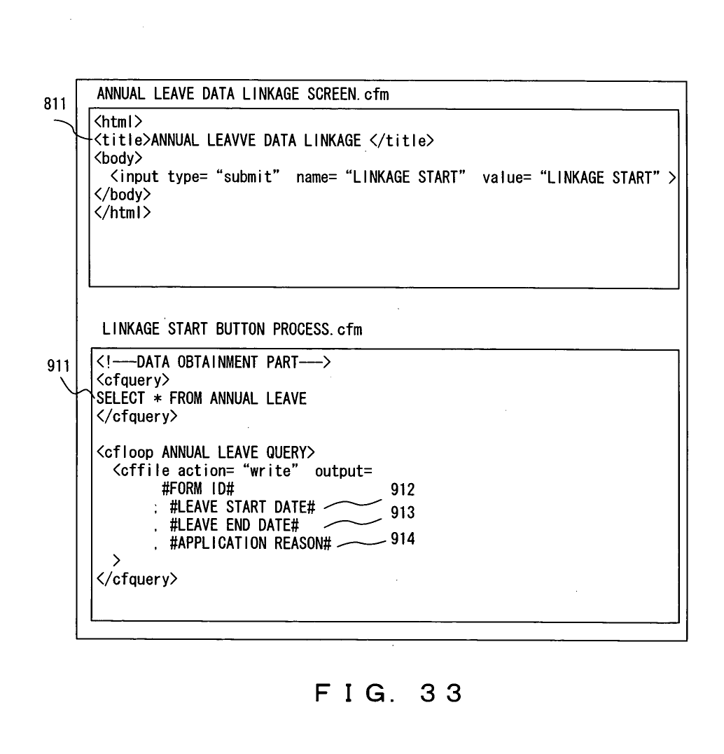

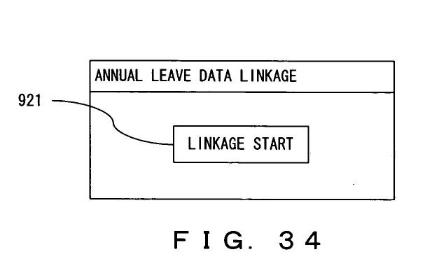

FIG. 33 exemplifies a source code of a data linkage program (annual leave data linkage program) generated with the data linkage program automatic generation process. FIG. 34 exemplifies a data linkage screen (annual leave data linkage screen) displayed when the data linkage program is executed. The annual leave data linkage program shown in FIG. 33 is composed of a file of a screen source code “annual leave data linkage screen.cfm”, and a file of a linkage start button press time process source code “linkage start button process.cfm”.

The work flow program generating apparatus first generates a screen source code (steps S801 to S803), and next generates a linkage start button press time process source code (step S804).

In the generation of the screen source code, the data linkage screen template shown in FIG. 31 is first read (step S801), a title is created from the form name of the form screen design information A (step S802), and a generated screen source code is stored (step S803). For example, the form name is “annual leave” in the form screen design information A shown in FIG. 2. Therefore, a title 811 (annual leave data linkage) shown in FIG. 33 is created.

In the generation of the linkage start button press time process source code, the linkage start button template shown in FIG. 32 is first read (step S901 of FIG. 30), and a data obtainment part including the table name of the form table is created from the form name of the form screen design information A (step S902). For example, the form name is “annual leave” in the form screen design information A shown in FIG. 2. Therefore, a data obtainment part 911 shown in FIG. 33 is created. In the data obtainment part 911, it is described that data to be obtained is the annual leave table.

Next, a screen item creation process (step S903) is repeated by the number of items of the form screen design information A, and a generated linkage start button press time process source code is stored (step S904). In this screen item creation process, an item of the form screen design information A is created as an item output part.

For example, the three items such as the “leave start date”, the “leave end date”, and the “application reason” are defined in the form screen design information A shown in FIG. 2. Therefore, three screen items 912, 913, and 914 shown in FIG. 33 are created as item output parts.

When the annual leave data linkage program thus generated is executed, the annual leave data linkage screen shown in FIG. 34 is displayed. With the press (click) of a linkage start button 921 by an operator, data of each form is read from the annual leave table, and converted into a file format used in a linkage destination system.

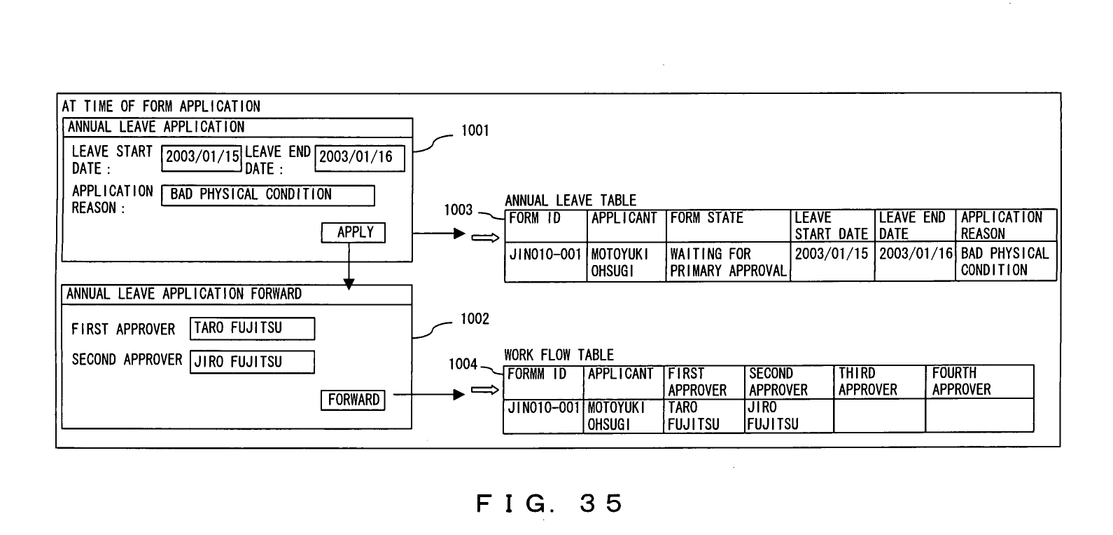

Specific examples of processes, which are executed by a form processing system where generated work flow application software is installed, are described next with reference to FIGS. 35 to 37.

FIG. 35 shows a specific example of a process executed when a form application is made. Firstly, when a user (Motoyuki Ohsugi) who makes an application inputs necessary items to an annual leave application screen 1001, and clicks an apply button, the form processing system stores data of the form of application in an annual leave table 1003, and sets the form state to “waiting for primary approval”. Then, the form processing system displays an annual leave application forward screen 1002.

Next, when the user inputs necessary items to the annual leave application forward screen 1002, and clicks a forward button, the form processing system stores data of the form of application in a work flow table 1004.

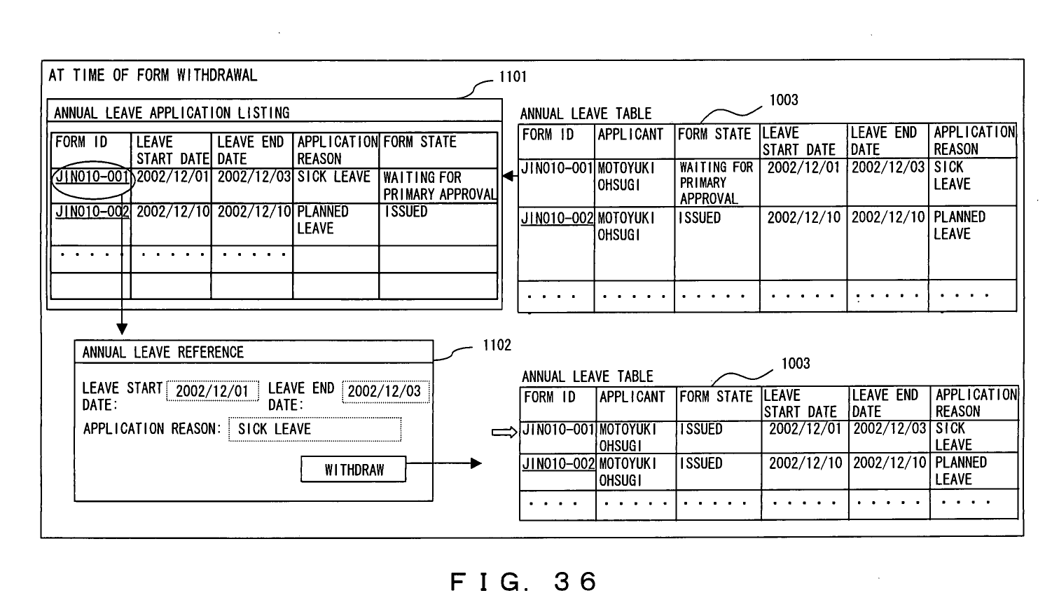

FIG. 36 shows a specific example of a process executed when a form is withdrawn. Firstly, the form processing system obtains from an annual leave table 1003 data of a form the applicant of which is a user who makes a withdrawal (Motoyuki Ohsugi), and displays an annual leave application listing screen 1101. Next, when the user clicks a form ID on the annual leave application listing screen 1101, the form processing system displays data of the form on an annual leave reference screen 1102.

Next, when the user clicks a withdraw button on the annual leave reference screen 1102, the form processing system sets the form state of the form in the annual leave table 1003 to “issued”.

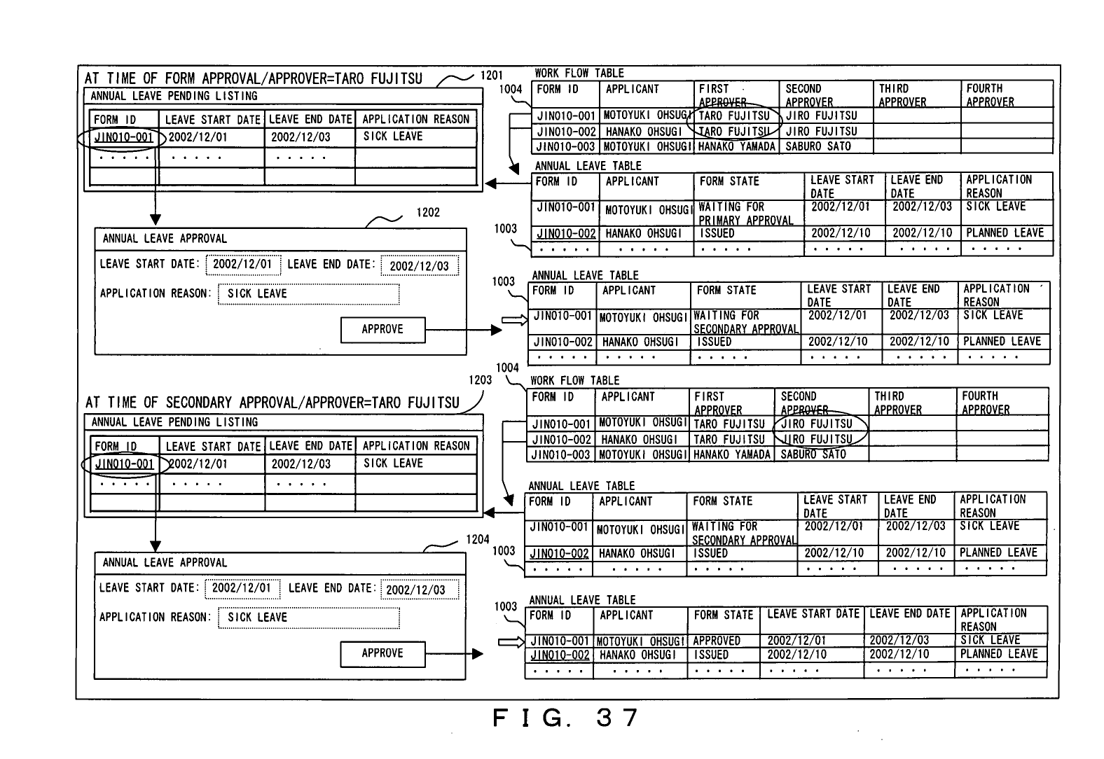

FIG. 37 shows a specific example of a process executed when a form is approved. Firstly, at the time of primary approval, the form processing system obtains from a work flow table 1004 a form ID of a form the first approver of which is a user who gives approval (Taro Fujitsu). Then, the form processing system refers to an annual leave table 1003 by using the obtained form ID as a key, obtains data of a form the form state of which is “waiting for primary approval”, and displays an annual leave pending listing screen 1201. Next, when the user clicks the form ID on the annual leave pending listing screen 1201, the form processing system displays data of the form on an annual leave approval screen 1202.

Next, when the user clicks an approve button on the annual leave approval screen 1202, the form processing system sets the form state of the form in the annual leave table 1003 to “waiting for secondary approval”.

Then, at the time of secondary approval, the form processing system obtains from the work flow table 1004 a form ID of a form the second approver of which is a user who gives approval (Jiro Fujitsu). Then, the form processing system refers to the annual leave table 1003 by using the obtained form ID as a key, obtains data of a form the form state of which is “waiting for secondary approval”, and displays an annual leave pending listing screen 1203. Next, when the user clicks a form ID on the annual leave pending listing screen 1203, the form processing system displays data of the form on an annual leave approval screen 1204.

Then, when the user clicks an approve button on the annual leave approval screen 1204, the form processing system sets the form state of the form in the annual leave table 1003 to “approved”.

The above described preferred embodiment mainly refers to the form processes for managing a leave application. However, the present invention is not limited to this implementation, and applicable to arbitrary form processes based on a work flow. Additionally, the present invention is similarly applicable to a case where a document or other information is processed instead of a form based on a work flow.

Furthermore, the automatic generation process according to the present invention is not limited to the process for generating all of the seven types of programs, which is shown in FIG. 3, and may be a process for generating some of these programs.

The work flow program generating apparatus shown in FIG. 1, and the form processing system executing a generated work flow program can be configured, for example, with an information processing device (computer) shown in FIG. 38. The information processing device shown in FIG. 38 comprises a CPU (Central Processing unit) 1301, a memory 1302, an input device 1303, an output device 1304, an external storage device 1305, a medium driving device 1306, and a network connecting device 1307, which are interconnected by a bus 1308.

The memory 1302 includes, for example, a ROM (Read Only Memory), a RAM (Random Access Memory), etc., and stores a program and data, which are used in a process. The CPU 1301 executes a necessary process by executing a program with the use of the memory 1302.

A program for executing the automatic generation process shown in FIG. 3, and each program of work flow application software generated with the automatic generation process correspond to a program stored in the memory 1302.

Additionally, the form screen design information A and the form flow design information B, which are shown in FIG. 2, the application screen template shown in FIG. 5, the apply button process template shown in FIG. 6, the application forward screen template shown in FIG. 10, the forward button process template shown in FIG. 11, the listing screen template shown in FIG. 15, the reference screen template shown in FIG. 19, the approval screen template shown in FIG. 26, the data linkage screen template shown in FIG. 31, and the linkage start button template shown in FIG. 32 correspond to data stored in the memory 1302.

The input device 1303 is, for example, a keyboard, a pointing device, a touch panel, etc., and used to input an instruction or information from a user. The output device 1304 is, for example, a display, a printer, a speaker, etc., and used to output an inquiry to a user or a process result.

The external storage device 1305 is, for example, a magnetic disk device, an optical disk device, a magneto-optical disk device, a tape device etc. The information processing device stores the above described program and data in this external storage device 1305, and loads the program and the data into the memory 1302 and uses them depending on need. The external storage device 1305 is also used as a database storing a form table and a work flow table.

The medium driving device 1306 drives a portable storage medium 1309, and accesses its stored contents. The portable storage medium 1309 is an arbitrary computer-readable storage medium such as a memory card, a flexible disk, a CD-ROM (Compact Disk-ReadOnlyMemory), an optical disk, a magneto-optical disk, etc. A user stores the above described program and data onto the portable storage medium 1309, and loads the program and the data into the memory 1302 and uses them depending on need.

The network connecting device 1307 is connected to an arbitrary communications network such as a LAN (Local Area Network), the Internet, etc., and performs data conversion accompanying a communication. As occasion demands, the information processing device receives the above described program and data from an external device via the network connecting device 1307, loads the program and data into the memory 1302, and uses them.

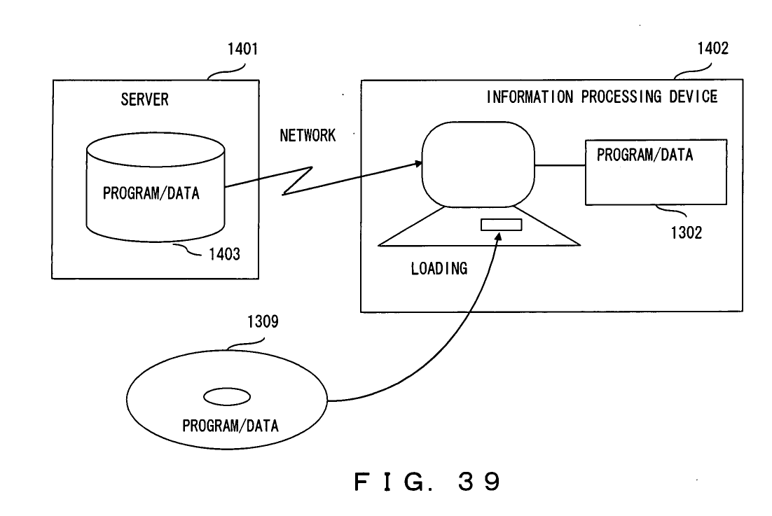

FIG. 39 shows computer-readable storage media which can provide a program and data to the information processing device shown in FIG. 38. The program and the data stored onto the portable storage medium 1309 or in a database 1403 of a server 1401 are loaded into the memory 1302 of the information processing device 1402. The server 1401 generates a propagation signal for propagating the program and the data, and transmits the signal to the information processing device 1402 via an arbitrary transmission medium on a network. The CPU 1301 executes a necessary process by executing the program with the data.

According to the present invention, a flow control program is automatically generated, whereby the amount of operations of a programmer is significantly reduced, and the development efficiency of work flow application software is increased.

What is claimed is:

1. A work flow program generating apparatus, comprising:
a storing device to store flow definition information which defines information for controlling a work flow, and screen definition information which defines screen items of a plurality of screens used in the work flow; and
a generating device to read the flow definition information and the screen definition information from said storing device, and to generate a screen program, which includes a program code for controlling a flow among the plurality of screens, by using the read flow definition information and screen definition information.

2. A computer-readable storage medium on which is recorded a program for causing a computer to execute a process, the process comprising:
reading, from a storing device, flow definition information which defines information for controlling a work flow, and screen definition information which defines screen items of a plurality of screens used in the work flow; and
generating a screen program, which includes a program code for controlling a flow among the plurality of screens, by using the read flow definition information and screen definition information.

3. A computer-readable storage medium on which is recorded a program for causing a computer to execute a process, the process comprising:
reading, from a storing device, flow definition information which defines information for controlling a work flow of a form process, and screen definition information which defines screen items of a plurality of screens used in the work flow;
generating a screen program for displaying a screen, on which data for updating a form table storing form data is input, and a screen program for displaying a screen, on which data of the form table is referred to, by using the read screen definition information;
generating a screen program for displaying a screen, on which data for updating a work flow table storing data of the work flow of the form process is input, by using the read flow definition information and screen definition information; and
generating a screen program for displaying a screen, on which data of the form table is referred to, based on the data of the work flow table by using the read screen definition information.

4. A computer-readable storage medium on which is recorded a program for causing a computer to execute a process, the process comprising:
reading, from a storing device, flow definition information which defines a number of hierarchical levels, on each of which an approver gives approval to a form, in a work flow of a form process; and
generating a screen program for displaying a screen, which includes input items of approvers by the number of hierarchical levels, by using the read flow definition information.

5. The computer-readable storage medium according to claim 4, wherein
the computer reads, from the storing device, screen definition information which defines screen items of a screen used in the work flow of the form process, and generates a screen program for displaying a listing screen of forms, which wait for approval given by the approvers, by using the read screen definition information.

6. A computer-readable storage medium on which is recorded a program for causing a computer to execute a process, the process comprising:
reading, from a storing device, flow definition information which defines presence/absence of withdrawal of a form forwarded in a work flow of a form process; and
generating a screen program for displaying a screen, which includes a button for withdrawing a form, if the read flow definition information indicates the presence of withdrawal, and generating a screen program for displaying a screen, which does not include a button for withdrawing a form, if the flow definition information indicates the absence of withdrawal.

7. A propagation signal for propagating a program to a computer, the program causing the computer to execute a process, the process comprising:
reading, from a storing device, flow definition information which defines information for controlling a work flow, and screen definition information which defines screen items of a plurality of screens used in the work flow; and
generating a screen program including a program code for controlling a flow among the plurality of screens by using the read flow definition information and screen definition information.

8. A work flow program generating method, comprising:
reading, from a storing device, flow definition information which defines information for controlling a work flow, and screen definition information which defines screen items of a plurality of screens used in the work flow, by a generating device; and
generating a screen program including a program code for controlling a flow among the plurality of screens by using the read flow definition information and screen definition information, by the generating device.

9. A work flow program generating apparatus, comprising:
storing means for storing flow definition information which defines information for controlling a work flow, and screen definition information which defines screen items of a plurality of screens used in the work flow; and
generating means for reading the flow definition information and the screen definition information from said storing means, and for generating a screen program, which includes a program code for controlling a flow among the plurality of screens, by using the read flow definition information and screen definition information.
